(19) United States
(12) Patent Application Publication
(10) Pub. No.: US 2009/0147982 A1
(43) Pub. Date: Jun. 11, 2009

(54) HEADPHONE SET AND HEADPHONE CABLE

(75) Inventors: Hiroyuki ASHIDA, Kyoto (JP); Satoshi KAWAHARA, Kyoto (JP)

Correspondence Address: CANTOR COLBURN, LLP, 20 Church Street, 22nd Floor, Hartford, CT, 06103, US

(73) Assignee: ROHM CO., LTD., Kyoto (JP)

(21) Appl. No.: 12/330,148

(22) Filed: Dec. 8, 2008

(30) Foreign Application Priority Data
Dec. 6, 2007 (JP) 2007-316068
Dec. 6, 2007 (JP) 2007-316082
Dec. 6, 2007 (JP) 2007-316303

(51) Int. Cl. H04R 25/00

(52) U.S. Cl. 381/384

(57) ABSTRACT

A cable distributes first and second audio signals outputted from a sound source to first and the second casings. A first signal line is laid out between an input plug and a first terminal, and transmits the first audio signal. A second signal line is laid out between an input plug and a second terminal, and transmits the second audio signal. A third signal line is laid out between the first terminal and the second terminal, in parallel to the first signal line and the second signal line, through the input plug.

### BACKGROUND OF THE INVENTION

1. Field of the Invention

The present invention relates to headphone sets.

2. Description of the Related Art

In order to provide a comfortable sound reproduction environment in a noisy location such as where there are crowds or on a train, headphone sets having a noise canceling function are being developed. In noise canceling, surrounding noise (ambient sound) is collected by a microphone, phase thereof is inverted, and superimposition is performed on a sound signal to be reproduced from a speaker. As a result, components of ambient sound outputted from the speaker and actual ambient sound cancel out, and a human ear perceives only sound (audio) signal components.

Patent Document 1: Japanese Patent Application, Laid Open No. 2004-214765

Patent Document 2: Japanese Patent Application, Laid Open No. H11-187476

Patent Document 3: Japanese Patent Application, Laid Open No. H8-123438

Patent Document 4: Japanese Patent Application, Laid Open No. H2-008098

Patent Document 5: Japanese Patent Application, Laid Open No. 2007-110536

Patent Document 6: Japanese Patent Application, Laid Open No. H10-294989

Patent Document 7: Japanese Translation of PCT International Publication, Publication No. 2004-526375

Problem 1: FIG. 1 is a drawing showing a configuration example of a headphone set 200 having a noise canceling function. The headphone set 200 having a noise canceling function is provided with a first casing 50a and a second casing 50b that fit to respective left and right ears, and a cable 52. The first casing 50a and the second casing 50b are connected by an arm 56. In cases in which the noise canceling function is provided independently for both left and right channels, noise canceling circuits 58a and 58b for canceling noise are installed in the first casing 50a and the second casing 50b respectively.

In cases in which a battery 60 is installed in only one of the casings (for example, the first casing 50a), in order to supply battery voltage to the other (second casing 50b side) noise canceling circuit 58b, wiring 62 is laid out inside the arm 56 of the headphone set 200.

In general, in order to improve fitting of the headphone set 200, the arm 56 is commonly configured to be expandable/contractible, in accordance with size and shape of a user's head. Alternatively, in order to improve portability of the headphone set, there are also foldable configurations.

However, if the wiring for supplying a power supply voltage from one casing to the other casing is laid out inside the arm, there have been cases in which the wiring affects the movability of the arm. Or, if wiring which does not affect the movability is used, there have been problems in that durability of the wiring is sacrificed. Such problems may occur not only in headphone sets provided with a noise canceling function.

Problem 2: FIGS. 3A to 3C are drawings showing configuration examples of an internal circuit of the headphone set having a noise canceling function, and characteristics thereof. The circuit of FIG. 3A is installed in each of the two casings respectively fitted to the left and right ears. The headphone set 200 is provided with a microphone 16, a noise canceling circuit 21a, and a speaker 14. The microphone 16 collects ambient sound. A microphone-amplifier 22 of the noise canceling circuit 21a amplifies a signal (ambient sound signal) in accordance with ambient sound collected by the microphone 16. A phase adjustment circuit 24 adjusts phase of the amplified ambient sound signal. A speaker amplifier 26 performs phase inversion of the ambient sound signal whose phase has been adjusted, superimposes the resulting signal on an audio signal S1, to be outputted from the speaker 14, and drives the speaker 14.

FIG. 3B is a drawing showing phase difference between the ambient sound signal collected by the microphone 16, and the ambient sound signal outputted from the speaker 14. In order to perform ideal noise canceling, it is desirable that the phase difference is uniformly adjusted at 180 degrees, for all frequency ranges. However, with an actual phase characteristic, above a certain frequency, for example from a vicinity of 1 kHz, phase begins to rotate. As a result, a component of a high frequency range outputted from the speaker 14 is not canceled but is added to the actual ambient sound, thus being amplified, and forming noise.

FIG. 3C is a drawing showing one example of a pass characteristic of noise outputted from the speaker 14. The noise mainly originates from active devices used in the microphone-amplifier 22, the phase adjustment circuit 24, and the speaker-amplifier 26, and has a tendency to become larger the higher the frequency becomes.

Such noise causes irritation with respect to a human's sense of hearing, particularly in a silent state.

Problem 3. A headset is used for making a hands-free telephone call using a mobile telephone, a fixed-line telephone, or an IP (Internet Protocol) telephone. FIG. 7 is a drawing showing a configuration of a general headset. The headset 300 is provided with casings 302a and 302b fitted to left and right ears respectively, and a transmission microphone 306. Speakers 304a and 304b are built into the casings 302a and 302b. There are also headsets that have only one of either the left and right casings.

In the headset of FIG. 7, when surrounding noise (ambient sound) is large, since speech spoken by oneself becomes hard to hear, a user of the headset has to speak with a loud voice. Furthermore, there is a problem in that, since a microphone for transmitting speech is exposed, ambient sound is transmitted to another party, and speech spoken by the user becomes hard to hear for the other party.

### SUMMARY OF THE INVENTION

The present invention has been made in view of this situation.

1. An exemplary purpose in an embodiment thereof is to provide a headphone set in which wiring along an arm is unnecessary;

2. an exemplary purpose in another embodiment thereof is to provide noise canceling technology which enables curtailing of high frequency noise; and

3. an exemplary purpose in a further embodiment thereof is to provide a headset that enables comfortable telephone calls.

1. With regard to the abovementioned problem 1, an embodiment of the present invention relates to a headphone set which converts an audio electrical signal outputted from a sound source into a sound signal. This headphone set is provided with a first casing, a second casing, and a cable. The first casing includes a battery, a first speaker, a first microphone, and a first drive circuit which performs phase inversion of a sound signal collected by the first microphone, superimposes a resulting signal on a first audio signal that has been inputted, and drives the first speaker. The second casing includes a second speaker, a second microphone, and a second drive circuit which performs phase inversion of a sound signal collected by the second microphone, superimposes a resulting signal on a second audio signal that has been inputted, and drives the second speaker. The cable distributes the first and the second audio signals outputted from the sound source to the first and the second casings. The cable is provided with an attachable/detachable input plug; a first terminal to be connected to the first casing; a second terminal to be connected to the second casing; a first signal line, laid out between the input plug and the first terminal, for transmitting the first audio signal; a first ground line, laid out between the input plug and the first terminal, forming a pair with the first signal line; a second signal line, laid out between the input plug and the second terminal, for transmitting the second audio signal; a second ground line, laid out between the input plug and the second terminal, forming a pair with the second signal line; and a third signal line laid out in parallel to the first signal line and the second signal line, between the first terminal and the second terminal, through the input plug. The first drive circuit receives a power supply from the battery, via wiring laid out inside the first casing, and the second drive circuit receives a power supply from the battery, via the third signal line.

A headphone set is a device that provides a sound signal to a human's left and right ears, without consideration being given to device size. Therefore, the headphone set includes earphones, headsets for telephone calls, and the like. According to this embodiment, wiring along the arm is unnecessary.

The first and the second drive circuits may each include a microphone-amplifier that amplifies output of a corresponding microphone, a phase adjustment circuit which adjusts phase of output of the microphone-amplifier, a speaker-amplifier which amplifies output of the phase adjustment circuit, and a signal adder circuit which superimposes output of a corresponding speaker-amplifier on a corresponding audio signal that has been inputted, and outputs to the corresponding speaker.

Another embodiment of the invention relates to a headphone cable for connecting a headphone set having a first casing and a second casing, to a sound source. The headphone cable is provided with an attachable/detachable input plug; a first terminal to be connected to the first casing; a second terminal to be connected to the second casing; a first signal line, laid out between the input plug and the first terminal, for transmitting a first audio signal; a first ground line, laid out between the input plug and the first terminal, forming a pair with the first signal line; a second signal line, laid out between the input plug and the second terminal, for transmitting the second audio signal; a second ground line, laid out between the input plug and the second terminal, forming a pair with the second signal line; and a third signal line, laid out in parallel to the first signal line and the second signal line, between the first terminal and the second terminal, through the input plug.

According to this embodiment, wiring along the arm is unnecessary.

The third signal line may be used for forming an identical potential at each of the first casing and the second casing.

The third signal line may be used for supplying a voltage of a battery installed in one of the first and the second casings, to the other casing.

2. With regard to the abovementioned problem 2, an embodiment of the present invention relates to a headphone set which converts an audio electrical signal outputted from a sound source into a sound signal. The headphone set is provided with a speaker, a microphone, a speaker-amplifier which performs phase inversion of a sound signal collected by the microphone, and superimposes a resulting signal on an audio signal that has been inputted, and a filter, arranged between the speaker-amplifier and the speaker, and configured such that a pass characteristic thereof is variable.

A headphone set is a device that provides a sound signal to the human ear, without consideration being given to device size. Therefore, the headphone set includes earphones, headsets for telephone calls, and the like. According to this embodiment, it is possible to remove uncomfortable noise, by switching pass characteristic of the filter in accordance with reproduction environment.

The filter may be configured to be switchable between at least two states: a first state in which at least an audio range is allowed to pass, and a second state having a pass characteristic designed with reduction of noise as an object.

The filter may function as a low pass filter, in the second state.

The filter may be configured so that, in the first state, an output signal of the speaker-amplifier passes through as it is.

The filter may include a resistor arranged between the speaker-amplifier and the speaker, and a capacitor and a switch arranged in series between a connection point of the speaker and the resistor, and a fixed voltage terminal.

In such cases, the filter can be made inactive by turning the switch OFF, and output of the speaker-amplifier can be supplied to the speaker.

The filter may be a low pass filter in which a cut-off frequency is switchable in the first and second states. The cut-off frequency in the second state of the low pass filter may be set lower than an upper frequency limit of the audible range.

The headphone set in a certain embodiment may be further provided with a level detection circuit which determines a level of the audio signal. A state of the filter maybe switched based on a determination result of the level detection circuit.

When the level of the audio signal is low, or when the audio signal is not inputted, the human ear easily perceives high frequency noise. Therefore, by automatically switching the state of the filter according to the level of the audio signal, noise from the speaker can be preferably curtailed.

Another embodiment of the present invention is a noise canceling circuit. This noise canceling circuit is provided with a microphone-amplifier which amplifies a sound signal collected by a microphone, a phase adjustment circuit which adjusts phase of an output signal of the microphone-amplifier, a speaker-amplifier which superimposes an output signal of the phase adjustment circuit on an audio signal that has been imputed, and outputs a resulting signal, and a level detection circuit which determines a level of the audio signal. A signal in response to a determination result of the level detection circuit is outputted for switching a range of a filter disposed outside the noise canceling circuit in a back stage of the speaker-amplifier.

The noise canceling circuit may be further provided with a filter control switch, one end of which is grounded, and a signal in response to a determination result of the level detection circuit is inputted to a control terminal. The other end of the filter control switch may be connected to the filter.

An even further embodiment of the present invention is a noise canceling method. This method includes amplifying an ambient sound signal collected by a microphone, adjusting a phase of the amplified ambient sound signal, superimposing, by a speaker-amplifier, the ambient sound signal whose phase has been adjusted, on an audio signal that has been inputted, determining a level of the audio signal, outputting output of the speaker-amplifier to a speaker, when the level of the audio signal is higher than a predetermined threshold, and filtering output of the speaker-amplifier and outputting to the speaker, when the level of the audio signal is lower than the threshold.

3. With regard to the abovementioned problem 3, in a headset of an embodiment of the present invention, a first microphone, a second microphone, a speaker, and a noise canceling circuit in which a sound signal collected by the first microphone undergoes phase inversion to be superimposed on a sound signal from another party, to be outputted to the speaker, are built into the same casing. The headset outputs a sound signal collected by the second microphone to the other party.

By designing so that a frequency range in which sound isolation by the noise canceling circuit is possible and a frequency range in which sound isolation by a casing is possible are staggered with regard to the frequency range of a human voice, output is possible without canceling the voice of a user of the headset, together with a sound signal from the other party. Since, in a state in which ambient sound is removed, the user hears his or her own voice from the speaker, there is no longer a need to speak with a loud voice, and a comfortable telephone call is possible.

The headset may superimpose a signal obtained by performing phase inversion of a sound signal from the other party, on a sound signal collected by the second microphone, and may perform output to the other party.

A further embodiment of the present invention also relates to the headset. In this headset a microphone, a speaker, and a noise canceling circuit in which a sound signal collected by the microphone undergoes phase inversion to be superimposed on a sound signal from another party and outputted to the speaker, are built into the same casing. The headset outputs the sound signal collected by the microphone to the other party.

The headset may be further provided with a filter which removes a high frequency component of the sound signal collected by the microphone, and output of the filter may be transmitted to the other party.

By removing high frequency ambient sound by the filter, it is possible to remove noise from sound transmitted to the other party.

It is to be noted that any arbitrary combination or rearrangement of the above-described structural components and so forth is effective as and encompassed by the present embodiments.

Moreover, this summary of the invention does not necessarily describe all necessary features so that the invention may also be a sub-combination of these described features.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a drawing showing a configuration of a headphone set having a noise canceling function;

FIG. 2 is a drawing showing a configuration of the headphone set according to a first embodiment;

FIGS. 3A to 3C are drawings showing configuration examples of an internal circuit of the headphone set having a noise canceling function, and characteristics thereof;

FIG. 4 is a circuit diagram showing an internal configuration of a headphone set provided with a noise canceling circuit according to a second embodiment;

FIGS. 5A to 5C are drawings showing a sound isolation characteristic of the headphone set according to embodiment 2;

FIG. 6 is a drawing showing a configuration example of a phase adjustment circuit;

FIG. 7 is a drawing showing a configuration of a general headset;

FIG. 8 is a drawing showing a configuration of a headset according to a third embodiment;

FIG. 9 is a circuit diagram showing a configuration of internal parts of a first casing;

FIG. 10 is a drawing showing a sound isolation characteristic of the headset according to the third embodiment; and

FIG. 11 is a circuit diagram showing a configuration of internal parts of a first casing of a headset according to a modified example.

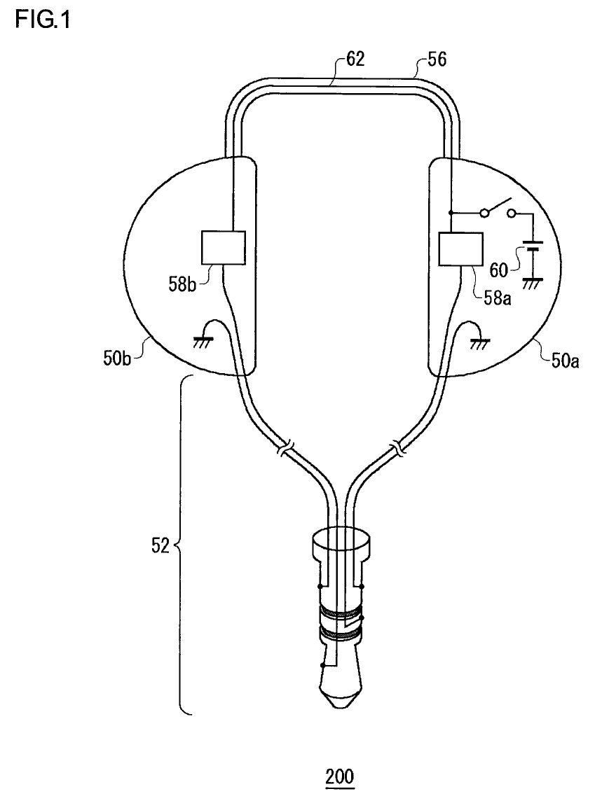

### DETAILED DESCRIPTION OF THE INVENTION

The invention will now be described based on preferred embodiments which do not intend to limit the scope of the present invention but exemplify the invention. All of the features and the combinations thereof described in the embodiment are not necessarily essential to the invention.

In the present specification, “a state in which member A is connected to member B” includes cases in which the member A and the member B are directly and physically connected, and cases in which the member A and the member B are indirectly connected via another member that does not affect an electrical connection state. In a similar way, “a state in which member C is arranged between member A and member B” includes, in addition to cases in which the member A and the member C, or the member B and the member C are directly connected, cases in which the members are indirectly connected via another member that does not affect an electrical connection state.

### First Embodiment

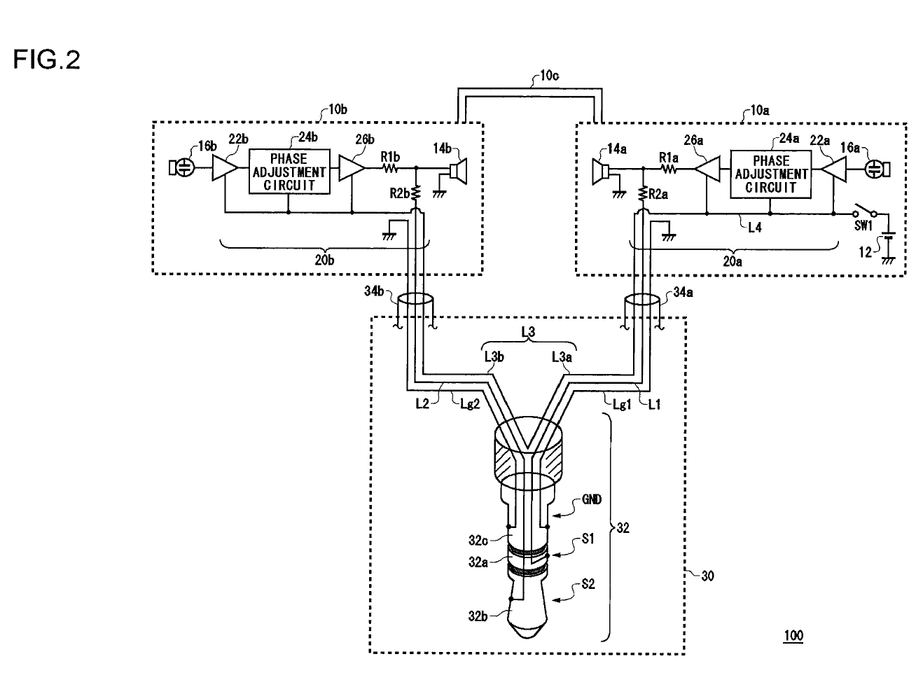

FIG. 2 is a drawing showing a configuration of a headphone set 100 according to a first embodiment. The headphone set 100 converts an audio electrical signal outputted from a sound source (not illustrated in the drawings) into a sound signal.

The headphone set is provided with a first casing 10a, a second casing 10b, a cable 30 and an arm 10c.

A battery 12, a first speaker 14a, a first microphone 16a, and a first drive circuit 20a are installed inside the first casing 10a.

The first microphone 16a picks up ambient sound and converts it into an electrical sound signal. The first drive circuit 20a is a noise canceling circuit, and performs phase inversion of a sound signal collected by the first microphone 16a and superimposes the resulting signal on a first audio signal S1, outputted from a sound source, to be outputted as a sound signal from the speaker 14, and drives the first speaker 14.

The first drive circuit 20a includes a microphone-amplifier 22a, a phase adjustment circuit 24a, a speaker-amplifier 26a, an adding resistor R1a, and an adding resistor R2a.

The microphone-amplifier 22a amplifies an output signal of the first microphone 16a. The phase adjustment circuit 24a adjusts the phase of output of the microphone-amplifier 22a. The speaker-amplifier 26a amplifies output of the phase adjustment circuit 24a. The adding resistor R1a and the adding resistor R2a superimpose output of the speaker-amplifier 26a on the first audio signal S1 inputted via the cable 30, and function as a signal adder circuit outputting to the first speaker 14a.

A second speaker 14b, a second microphone 16b and a second drive circuit 20b are installed inside the second casing 10b.

The second microphone 16b collects ambient sound and converts it into an electrical sound signal. The second drive circuit 20b is a noise canceling circuit, and performs phase inversion of a sound signal collected by the second microphone 16b and superimposes a resulting signal on a second audio signal S2, outputted from a sound source, and drives the second speaker 14b. The second drive circuit 20b is configured similarly to the first drive circuit 20a.

The first casing 10a and the second casing 10b are mechanically connected by the arm 10c.

The cable 30 distributes the first and the second audio signals S1 and S2 inputted from the sound source (not illustrated in the drawings) to an input plug 32, to the first casing 10a and the second casing 10b.

The cable 30, in addition to the input plug 32, is provided with a first terminal 34a, a second terminal 34b, a first signal line L1, a first ground line Lg1, a second signal line L2, a second ground line Lg2, and a third signal line L3.

The input plug 32 is a stereo pin jack, and is configured to be attachable and detachable with respect to a socket to which the audio signal is supplied. The input plug 32 is provided with a first terminal 32a, a second terminal 32b, and a ground terminal 32c. The first audio signal S1 is provided to the first terminal 32a, the second audio signal S2 is provided to the second terminal 32b, and a ground potential is provided to the ground terminal 32c.

The first terminal 34a of the cable 30 is connected to the first casing 10a. The second terminal 34b is connected to the second casing 10b.

The first signal line L1 is laid out between the input plug 32 and the first terminal 34a, and transmits the first audio signal S1. The first ground line Lg1 forms a pair with the first signal line L1, and is laid out along the first signal line L1 between the input plug 32 and the first terminal 34a.

That is, one end of the first signal line L1 is connected to the first terminal 32a of the input plug 32, and one end of the first ground line Lg1 is connected to the ground terminal 32c of the input plug 32.

In the same way, the second signal line L2 is laid out between the input plug 32 and the second terminal 34b, and transmits the second audio signal S2. The second ground line Lg2 forms a pair with the second signal line L2, and is laid out along the second signal line L2 between the input plug 32 and the second terminal 34b.

The third signal line L3 is laid out in parallel to the first signal line L1 and the second signal line L2, between the first terminal 34a and the second terminal 34b, through the input plug 32.

The first signal line L1, the first ground line Lg1, the second signal line L2, the second ground line Lg2, and the third signal line L3 are covered by an insulator, not illustrated in the drawings. That is, a group of the first signal line L1, the first ground line Lg1, and a portion L3a of the third signal line L3, and a group of the second signal line L2, the second ground line Lg2, and a portion L3b of the third signal line L3, each form single wiring when viewed from outside.

FIG. 2 shows wiring in which the cable 30 is branched in a V-shape with the input plug 32 as apex, but a Y-shape is also possible. Alternatively, other forms of wiring are also possible.

The first drive circuit 20a of the first casing 10a side receives a power supply from the battery 12 via a switch SW1 and wiring L4 laid out inside the first casing 10a. At the same time, the second drive circuit 20b of the second casing 10b side receives a power supply from the battery 12 via the third signal line L3.

By using the cable 30 according to the first embodiment, since it is not necessary to lay power supply wiring for supplying battery voltage to the second casing 10b from the first casing 10a inside the arm 10c, degree of freedom in design of the arm 10c is increased. Alternatively, the arm 10c need not be provided, so that design constraints are relaxed, contributing to providing the headphone set 100 having high quality design.

Furthermore, by forming the power supply wiring as the third signal line L3 that is laid out in parallel to the first signal line L1 and the second signal line L2 inside the cable 30, it is possible to reduce the likelihood of a breakage in the power supply wiring. This is because the cable 30 is formed of an insulating material that has high strength and flexibility.

A description has been given of cases in which the cable 30 according to the first embodiment is used in the headphone set 100 having a noise canceling function, but application of the cable 30 is not limited thereto, and can be used in various headphone sets in which the power supply is installed in one of the casings and a power supply voltage thereof is used for the other casing. In addition, application of the third signal line L3 of the cable 30 is not limited to transmission of the power supply voltage, and otherwise may be used for transmission of arbitrary signals.

A description has been given concerning a stereo headphone set in the first embodiment, but application is also possible to a mono headphone set. In such cases, it is only necessary to change the form of the input plug 32.

### Second Embodiment

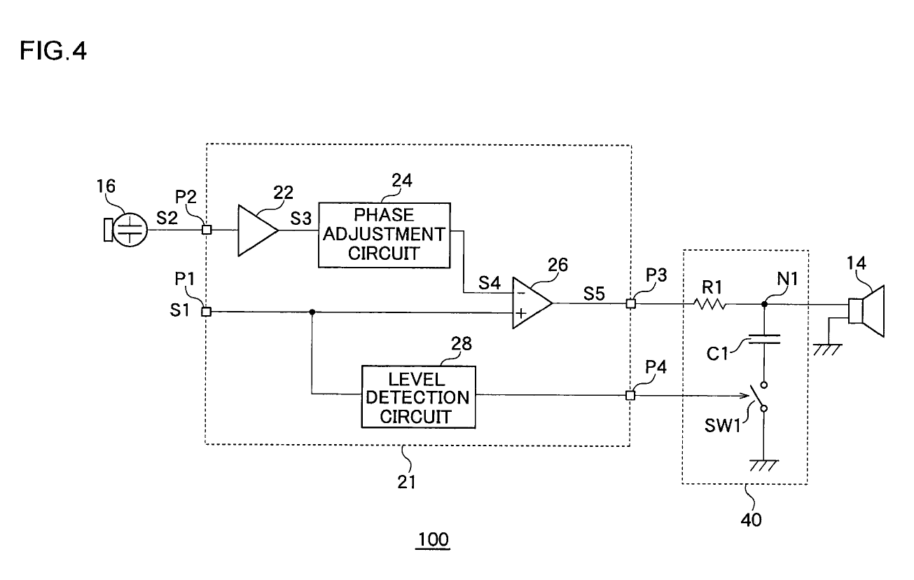

FIG. 4 is a circuit diagram showing an internal configuration of a headphone set 100 provided with a noise canceling circuit 21, according to a second embodiment. The headphone set 100 converts an audio electrical signal outputted from a sound source (not illustrated in the drawings) into a sound signal. FIG. 4 shows only one of left and right channels.

The headphone set 100 is provided with a speaker 14, a microphone 16, a noise canceling circuit 21, and a filter 40.

An audio signal S1 to be outputted from the speaker 14 is inputted to an audio input terminal P1 of the noise canceling circuit 21. The microphone 16 collects surrounding noise (ambient sound). A signal (referred to as an ambient sound signal) S2 collected by the microphone 16 is inputted to a microphone input terminal P2 of the noise canceling circuit 21.

The noise canceling circuit 21 includes a microphone-amplifier 22, a phase adjustment circuit 24, a speaker-amplifier 26, and a level detection circuit 28, and is a function IC integrated on one semiconductor substrate.

The microphone-amplifier 22 amplifies the ambient sound signal S2 collected by the microphone 16. The phase adjustment circuit 24 adjusts a phase pass characteristic of an ambient sound signal S3 that has been amplified. The speaker-amplifier 26 outputs, from an audio output terminal P3, a signal obtained by performing phase inversion of the ambient sound signal S4 whose phase has been adjusted, and superimposing on the audio signal S1. The speaker 14 is driven by a signal from the audio output terminal P3.

The filter 40 which filters an output signal S5 of the speaker-amplifier 26 is provided between the speaker-amplifier 26 and the speaker 14 outside the noise canceling circuit 21.

The filter 40 is configured such that the pass characteristic is variable. Specifically, the filter 40 is configured to be switchable between at least two states: a first state in which at least an audio range (in general, in the order of the audible range of 20 Hz to 20 kHz) is passed, and a second state that has a pass characteristic designed with noise reduction as an object.

A range in the second state is designed to be narrower than the audio range. The range of the second state is preferably designed so that any of the following conditions or a combination of several thereof are fulfilled.

Condition 1: Phase adjustment by the phase adjustment circuit 24 cuts off incomplete ranges.

Condition 2: A noise component originating in an active device within the noise canceling circuit 21 and outputted from the audio output terminal P3 cuts off ranges exceeding an allowable amount.

Condition 3: Considering auditory characteristics of the human ear, ranges in which humans easily perceive noise are cut off.

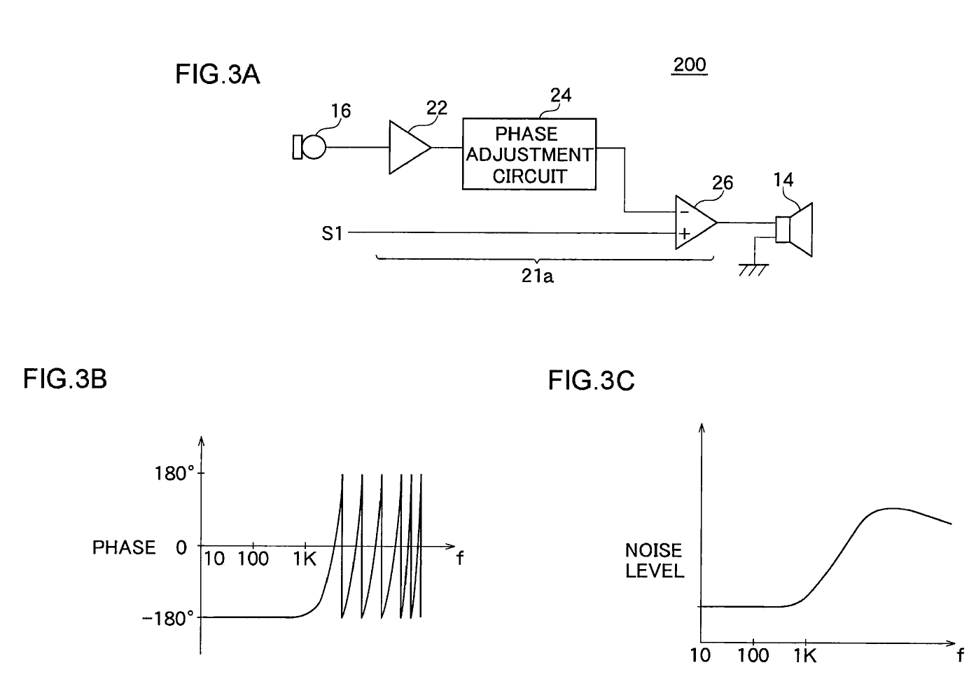

In cases according to Condition 1, ranges are decided based on a phase characteristic of FIG. 3B. In the phase characteristic of FIG. 3B, the filter 40 is designed such that, from a phase beginning to rotate at around 1 kHz, ranges of 1 kHz or greater are shut off.

In cases according to Condition 2, a range is designed based on a pass characteristic of noise outputted from the audio output terminal P3 of the noise canceling circuit 21. This noise has a tendency to become large as frequency becomes higher, and noise shown in FIG. 3C increases rapidly from a vicinity of where 1 kHz is exceeded. Consequently, the pass characteristic of the filter 40 is designed to be able to preferably remove noise generated by the noise canceling circuit 21. For example, in cases of FIG. 3C, the design may be such that a range of 1 kHz or greater is cut off.

The filter 40 of FIG. 4 may be configured to be switchable between being inactive and active. In an inactive state the filter 40 does not affect output of the speaker-amplifier 26 and outputs the output as it is. This state is equivalent to the first state in which an audio range is let pass through. When active, the filter 40 functions as a filter having a pass characteristic optimized for noise reduction.

In order to realize such functionality, the filter 40 is configured as a low pass filter including a resistor R1, a capacitor C1, and a filter control switch SW1.

The resistor R1 is arranged between an output terminal of the speaker-amplifier 26 and an input terminal of the speaker 14. The capacitor C1 and the filter control switch SW1 are arranged between a connection point N1 of the speaker 14 and the resistor R1, and a fixed voltage terminal (ground terminal). The filter 40 is inactive when the filter control switch SW1 is OFF, and is set to the first state in which the audio range is passed. When the filter control switch SW1 is ON, the filter 40 functions as a low pass filter for removing noise.

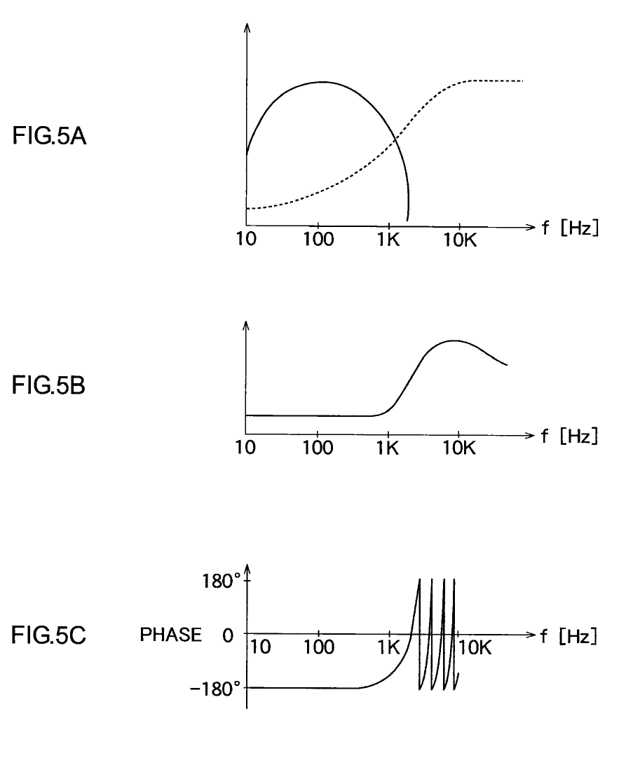

A cut-off frequency of the low pass filter may be set according to the abovementioned Condition 1 or/and Condition 2. Considering FIG. 3A and FIG. 5, if the cut-off frequency is approximately 1 kHz, it is possible to satisfy Conditions 1 and 2 (and 3) at the same time.

In general, the cut-off frequency of the filter 40 may be set lower than an upper limit frequency of the auditory range (15 k to 20 kHz), and is preferably set in a range of several 100 Hz to several kHz.

Configuration of the filter 40 is not limited to that of FIG. 4, and various forms of filter may be used. Instead of a low pass filter, the filter may be configured as a band pass filter or a band elimination filter.

The level detection circuit 28 determines a level of the audio signal S1. Specifically, the level detection circuit 28 includes a detector circuit and a comparator, the audio signal S1 is converted by the detection circuit into a DC signal having a level according to amplitude, and this is compared with a threshold by the comparator. A result of the comparison is outputted from a filter control terminal P4 to the filter 40.

The state of the filter 40 is switched according to a control signal S6 from the filter control terminal P4. That is, when the level of the audio signal S1 is larger than the threshold, the filter control switch SW1 is OFF. In other words, when the audio signal S1 has a significant level, the filter 40 is made inactive when audio is being reproduced, and the audio range is passed.

When the audio signal S1 is smaller than the threshold, the filter control switch SW1 is ON. In other words, when the audio signal S1 does not have a significant level, the filter 40 is made active when audio is not being reproduced, and noise is cut off.

The headphone set 100 is configured as above. Next, operation of the headphone set 100 is described.

1. Audio Reproduction State

When it is determined by the level detection circuit 28 that the audio signal S1 is being reproduced, the filter 40 is set to the first state. In such cases, noise generated by the noise canceling circuit 21, or noise due to not being able to preferably adjust a phase in the ambient sound signal S3, is outputted from the speaker 14. However, since high frequency noise is buried in the audio signal, it is difficult to perceive by the human ear. In the first state, by preferably canceling low frequency ambient sound signals that are easily perceived by the human ear, during reproduction of the audio signal S1, good audio reproduction is possible.

2. Audio Non-Reproduction State

In a non-reproduction state (silent state) of the audio signal S1, the filter 40 is set to the second state. In such cases, noise generated by the noise canceling circuit 21, or noise due to not being able to preferably adjust a phase in the ambient sound signal S3, is cut off by the filter 40.

FIGS. 5A to 5C are drawings showing a sound isolation characteristic of the headphone set 100 in a non-reproduction state of the audio. The solid line of FIG. 5A shows a sound isolation characteristic by the noise canceling circuit 21, and the broken line shows a sound isolation characteristic by a casing. FIG. 5B shows noise generated in the noise canceling circuit 21, and FIG. 5C shows phase difference between an ambient sound signal collected by the microphone 16 and an ambient sound signal outputted from the speaker 14.

The higher the frequency the more preferable the sound isolation characteristic possessed by the casing. Among ambient sound collected by the microphone 16, from the speaker 14, only components less than or equal to a cut-off frequency fc of the filter 40 undergo phase inversion to be outputted, and ranges above the cut-off frequency fc are cut off. In ranges less than or equal to the cut-off frequency fc, ambient sound signals passing the filter 40, that have undergone phase inversion, cancel ambient sound passing the casing, and preferable noise canceling is realized. Furthermore, in ranges above the cut-off frequency fc, noise canceling by the noise canceling circuit 21 is substantially made inactive by a low pass filter, but ambient sound that reaches the human ear can be cut off by sound isolation possessed by the casing itself.

According to the user, the headphone set having a noise canceling function may be used not only for a purpose of audio reproduction, but may also be used as ear plugs. For this application also, the headphone set 100 according to the second embodiment is very useful.

According to the second embodiment, noise in a silent state (a time of non-reproduction) can be preferably cutoff. Therefore, for active devices used internally in the noise canceling circuit 21, for example the microphone-amplifier 22, or the speaker-amplifier 26, expensive low noise devices are unnecessary. Therefore, it is possible to lower the cost of the noise canceling circuit 21.

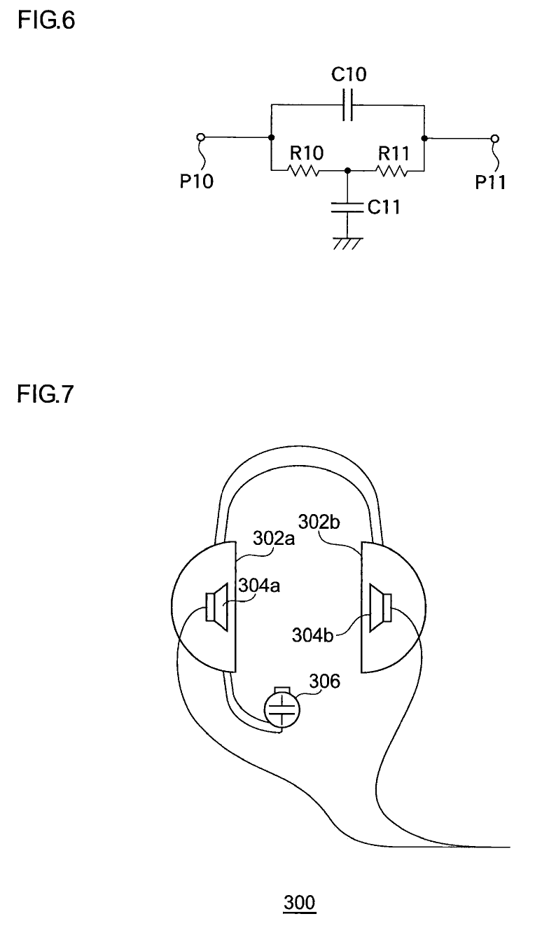

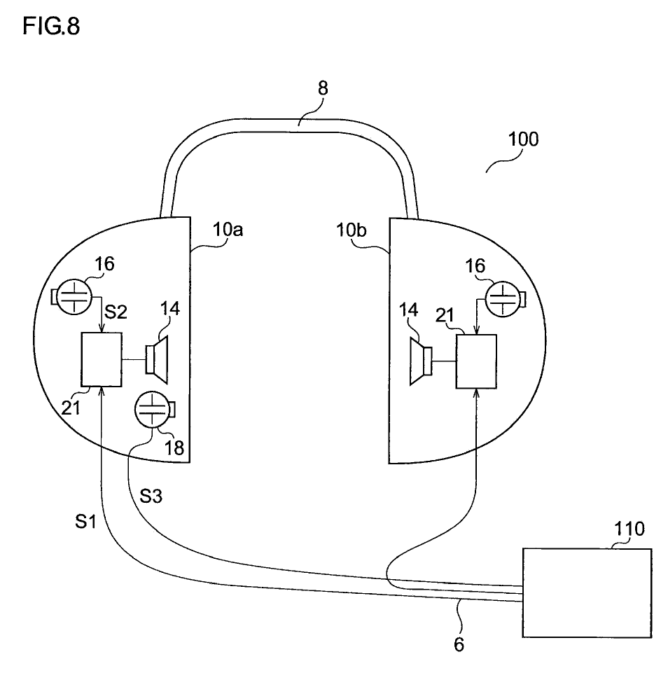

Furthermore, conventionally, since phase compensation for frequencies as high as possible is performed by the phase adjustment circuit 24, there has been a need to use a complicated circuit, but in the second embodiment, since a frequency range, for which phase compensation is not suitable, can be cut off by the filter 40, it is possible to simplify the configuration of the phase adjustment circuit 24. FIG. 6 is a drawing showing a configuration example of the phase adjustment circuit 24. A capacitor C10 is arranged between an input terminal P10 and an output terminal P11, and resistors R10 and R11 are serially connected, in parallel to the capacitor C10. A capacitor C11 is arranged between a connection point of the resistors R10 and R11 and a ground terminal. A plurality of phase adjustment circuits 24 of FIG. 6 may be arranged in a cascade, according to needs.

Configurations in which optional combinations of the abovementioned component elements and the component elements and representations of the invention are mutually substituted among methods, devices, and systems, are valid embodiments of the present invention. Below, a modified example is described.

In the second embodiment, a description was given of cases in which the filter 40 is arranged outside the noise canceling circuit 21, but some elements thereof maybe integrated inside the noise canceling circuit 21. For example, the filter control switch SW1 may be configured using a MOSFET, and arranged inside the noise canceling circuit 21.

The filter control switch SW1 may be turned ON and OFF based on an instruction of a user. In such cases, the filter control switch SW1 may be configured as a mechanical switch.

The filter 40 may be configured as a low pass filter in which a cut-off frequency is switchable. A first cut-off frequency is set to a value that does not affect audio range. A second cut-off frequency may be decided giving consideration to the abovementioned Conditions 1 to 3.

### Third Embodiment

FIG. 8 is a drawing showing a configuration of a headset 100 according to a third embodiment. The headphone set 100 is connected to a communication device 110 such as a mobile telephone, an IP telephone, a fixed line telephone, or the like, and is fitted to a user's head.

The headset 100 is provided with a first casing 10a and a second casing 10b that fit to respective left and right ears, and an arm 8 joining the casings. The headset 100 and the communication device 110 are connected by a cable 6. In the third embodiment, the headset may be either a stereo type or a mono type. Furthermore, the headset may be configured of only a single casing 10a fitted to one ear only.

A speaker 14, a first microphone 16, a second microphone 18, and a noise canceling circuit 20 are built-in, within the first casing 10a. The first microphone 16, is disposed directed towards the outside of the casing to collect ambient sound.

The noise canceling circuit 20 performs phase inversion of a sound signal S2 collected by the first microphone 16, superimposes a resulting signal on a sound signal (referred to as a receiver signal) S1 from another party, and outputs to the speaker 14. The headset 100 outputs to the other party, as a transmission signal, a sound signal S3 collected by the second microphone 18.

The second casing 10b has a configuration of that of the first casing 10a with the second microphone 18 removed.

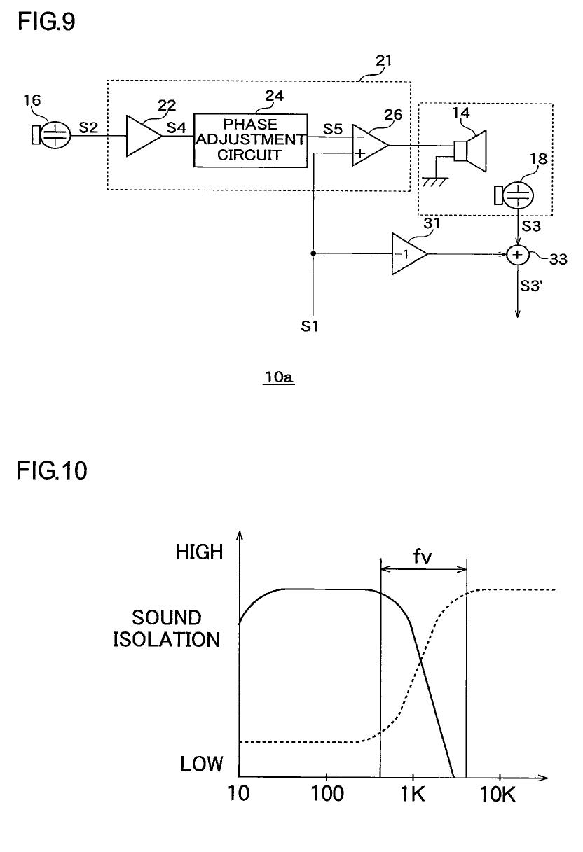

FIG. 9 is a circuit diagram showing a configuration of internal parts of the first casing 10a. The noise canceling circuit 20 includes a microphone-amplifier 22, a phase adjustment circuit 24, and a speaker-amplifier 26.

The microphone 16 collects ambient sound, to be converted into an electrical sound signal (below, referred to as an ambient sound signal) S2. The microphone-amplifier 22 amplifies the ambient sound signal S2 outputted from the first microphone 16. The phase adjustment circuit 24 adjusts the phase of output S4 of the microphone-amplifier 22. The speaker-amplifier 26 performs phase inversion of an ambient sound signal S5 whose phase has been adjusted, superimposes a resulting signal on the receiver signal S1, and drives the speaker 14.

An inverting amplifier 31 inverts the receiver signal S1. An adder 33 superimposes output*S1 of the inverting amplifier 31 on the sound signal S3 collected by the second microphone 18, and outputs to the communication device 110 as a transmission signal S3′. It should be noted that the speaker 14 and the second microphone 18 are arranged inside the same casing.

The above description is of a configuration of the headset 100. Next, operation of the headset 100 is described. FIG. 10 is a drawing showing a sound isolation characteristic of the headphone set 100 according to the third embodiment. A horizontal axis shows frequency and a vertical axis shows sound isolation level.

The solid line of FIG. 10 shows the sound isolation characteristic according to the noise canceling circuit 20, and the broken line shows the sound isolation characteristic according to casings that house the headset 100.

The noise isolation characteristic by the noise canceling circuit 20 indicates a noise canceling function, having a high level in a region in which frequency is low, with sound isolation level decreasing as frequency increases. This is because, in a region in which the frequency is low, since phase adjustment by the phase adjustment circuit 24 is preferably carried out, it is possible to perform 180-degree phase inversion from the speaker 14, of the sound signal S2 collected by the first microphone 16, to perform output. However, when the frequency is high, since a misalignment occurs in phase adjustment by the phase adjustment circuit 24, a phase characteristic of a route from the first microphone 16 to the speaker 14 is out of alignment by 180 degrees. As a result, the noise canceling performance deteriorates.

In FIG. 10, in addition to the sound isolation characteristics of the noise canceling circuit 20 and the casing 10, the frequency range fv of the human voice is shown. Since the human voice has a range extending from several 100 Hz to several kHz, it passes through the casing, and has a property of not easily being affected by noise canceling by the noise canceling circuit 20.

At this time, if the user of the headset 100 speaks, the speech that is spoken is collected by the first microphone 16, and passes through the casing 10 to be collected by the second microphone 18. At the same time, focusing on surrounding ambient sound, since a low frequency component thereof is isolated by the noise canceling circuit and a high frequency component thereof is isolated by the casing, sufficient attenuation occurs before the second microphone 18 is reached.

The headset 100 collects speech spoken by the user, by the second microphone 18, to be combined with the receiver signal S1 from the other party, and outputted as the transmission signal S3′. By disposing the second microphone 18 inside the casing 10, it is possible to transmit speech spoken by the user to the other party, while isolating the high frequency component of the ambient sound.

The user's ear is covered by the casing. Therefore, the high frequency component of the ambient sound is sufficiently attenuated before reaching the eardrum. Furthermore, the low frequency component of the ambient sound is cancelled by sound isolation by the noise canceling circuit 20, and is not easily perceived at the eardrum.

Speech as spoken by the user is focused upon. The speech as spoken by the user is collected by the first microphone 16. However, as shown in FIG. 10, the frequency range of the speech is located at a region in which sound isolation by the noise canceling circuit 20 decreases. Therefore, the user's speech outputted from the speaker 14, together with a sound signal transmitted from a human's mouth to the ear without passing through the noise canceling circuit 20, reach the user's eardrum without being mutually cancelled. As a result, the user can hear his or her own voice from the speaker 14.

That is, the user's own speech reaches the user's ear, which is covered by the casing, without the ambient sound reaching the ear. In general, people have a tendency to speak with a loud voice when their own voice is hard to hear, but if the headset 100 according to the third embodiment is used, it is no longer necessary to speak with a loud voice.

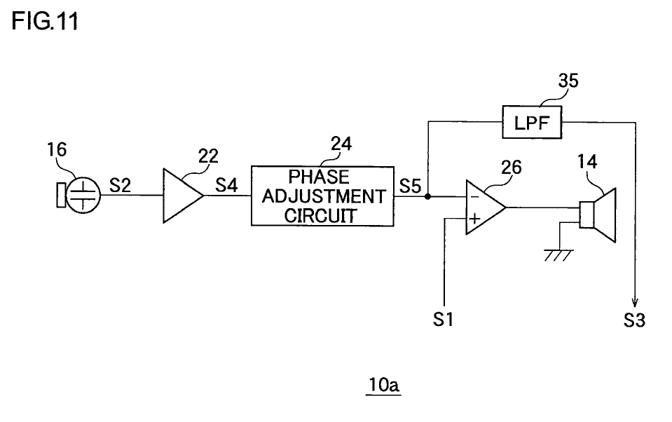

FIG. 11 is a circuit diagram showing a configuration of internal parts of the first casing 10a of the headset 100 according to a modified example. In the circuit of FIG. 11, the first microphone 16 is combined with functionality of the second microphone 18. That is, the configuration is one in which the second microphone 18, the inverting amplifier 31, and the adder 33 are removed from the circuit of FIG. 9.

The headset 100 according to the present embodiment outputs the sound signal collected by the first microphone 16 as the transmission signal S3 to the other party. Specifically, a high frequency component of the sound signal S5 whose phase has been adjusted by the phase adjustment circuit 24 is removed by a low pass filter 35, and outputted as the transmission signal S3.

By removing ambient sound outside of voice frequency range, by the low pass filter 35, it is possible to remove noise from sound transmitted to the other party.

According to the headset 100 of the present embodiment, a comfortable communication environment can be provided in the same way as the embodiment. Furthermore, since the number of microphones is reduced, it is possible to reduce circuit area and cost.

While the preferred embodiments of the present invention have been described using specific terms, such description is for illustrative purposes only, and it is to be understood that changes and variations may be made without departing from the spirit or scope of the appended claims.

What is claimed is:

1. A headphone set for converting an audio electrical signal outputted from a sound source to a sound signal, the headphone set comprising:
a first casing which comprises: a battery, a first speaker, a first microphone, and a first drive circuit which performs phase inversion of a sound signal collected by the first microphone, to be superimposed on a first audio signal that has been inputted, and drives the first speaker;
a second casing which comprises: a second speaker, a second microphone, and a second drive circuit which performs phase inversion of a sound signal collected by the second microphone, to be superimposed on a second audio signal that has been inputted, and drives the second speaker; and
a cable which distributes the first and the second audio signals outputted from the sound source, to the first and the second casings; wherein
the cable comprises:
an attachable/detachable input plug;
a first terminal to be connected to the first casing;
a second terminal to be connected to the second casing;
a first signal line, laid out between the input plug and the first terminal, which transmits the first audio signal;
a first ground line, laid out between the input plug and the first terminal, forming a pair with the first signal line;
a second signal line, laid out between the input plug and the second terminal, which transmits the second audio signal;
a second ground line, laid out between the input plug and the second terminal, forming a pair with the second signal line; and
a third signal line laid out in parallel to the first signal line and the second signal line, between the first terminal and the second terminal, through the input plug; and wherein
the first drive circuit receives a power supply from the battery, via wiring laid out inside the first casing; and
the second drive circuit receives a power supply from the battery, via the third signal line.

2. The headphone set according to claim 1, wherein the first and the second drive circuits each comprise:
a microphone-amplifier which amplifies output of a corresponding microphone;
a phase adjustment circuit which adjusts phase of output of the microphone-amplifier;
a speaker-amplifier which amplifies output of the phase adjustment circuit; and
a signal adder circuit which superimposes output of the corresponding speaker-amplifier, on a corresponding audio signal, and outputs to the corresponding speaker.

3. A headphone cable for connecting a headphone set having a first casing and a second casing to a sound source, the cable comprising:
an attachable/detachable input plug;
a first terminal to be connected to the first casing;
a second terminal to be connected to the second casing;
a first signal line, laid out between the input plug and the first terminal, which transmits the first audio signal;
a first ground line, laid out between the input plug and the first terminal, forming a pair with the first signal line;
a second signal line, laid out between the input plug and the second terminal, which transmits the second audio signal;
a second ground line, laid out between the input plug and the second terminal, forming a pair with the second signal line; and
a third signal line laid out in parallel to the first signal line and the second signal line, between the first terminal and the second terminal, through the input plug.

4. The headphone cable according to claim 3, wherein the third signal line is used for forming an identical potential at each of the first casing and the second casing.

5. The headphone cable according to claim 4, wherein the third signal line is used for supplying a voltage of a battery installed in one of the first and the second casings, to another of the first and the second casings.

6. A headphone set for converting an audio electrical signal outputted from a sound source, to a sound signal, the headphone set comprising:
a speaker;
a microphone;
a speaker-amplifier which performs phase inversion of a sound signal collected by the microphone, to be superimposed on an audio signal that has been inputted; and
a filter, arranged between the speaker-amplifier and the speaker, and configured such that a pass characteristic is variable.

7. The headphone set according to claim 6, wherein the filter is configured to be switchable between at least two states: a first state in which at least an audio range is allowed to pass, and a second state having a pass characteristic designed with reduction of noise as an object.

8. The headphone set according to claim 7, wherein the filter functions as a low pass filter, in the second state.

9. The headphone set according to claim 7, wherein the filter is configured so that in the first state an output signal of the speaker-amplifier passes through as it is.

10. The headphone set according to claim 7, wherein the filter comprises:
a resistor arranged between the speaker-amplifier and the speaker; and
a capacitor and a switch arranged in series between a connection point of the speaker and the resistor, and a fixed voltage terminal.

11. The headphone set according to claim 7, wherein the filter is a low pass filter in which a cut-off frequency is switchable in the first and second states.

12. The headphone set according to claim 6, further comprising a level detection circuit which determines a level of the audio signal, wherein
a state of the filter is switched based on a determination result of the level detection circuit.

13. A noise canceling circuit comprising:
a microphone-amplifier which amplifies a sound signal collected by a microphone;
a phase adjustment circuit which adjusts phase of an output signal of the microphone-amplifier;
a speaker-amplifier which superimposes an output signal of the phase adjustment circuit, on an audio signal that has been imputed, and outputs the resulting signal; and
a level detection circuit which determines a level of the audio signal; wherein
a signal in response to a determination result of the level detection circuit is outputted for switching a range of a filter disposed outside the noise canceling circuit, in a back stage of the speaker-amplifier.

14. The noise canceling circuit according to claim 13, further comprising:
a filter control switch, one end of which is grounded, a signal in response to a determination result of the level detection circuit being inputted to a control terminal; wherein
the other end of the filter control switch is connected to the filter.

15. A noise canceling method comprising:
amplifying an ambient sound signal collected by a microphone;
adjusting a phase of the amplified ambient sound signal;
superimposing, by a speaker-amplifier, the ambient sound signal whose phase has been adjusted, on an audio signal that has been inputted;
determining a level of the audio signal;
outputting an output of the speaker-amplifier to a speaker, when the level of the audio signal is higher than a predetermined threshold, and filtering an output of the speaker-amplifier, to be outputted to the speaker, when the level of the audio signal is lower than the threshold.

16. A headset comprising, built into a same casing:
a first microphone;
a second microphone;
a speaker; and
a noise canceling circuit in which a sound signal collected by the first microphone undergoes phase inversion to be superimposed on a sound signal from an other party, and is outputted to the speaker; wherein
a sound signal collected by the second microphone is outputted to the other party.

17. The headset according to claim 16, wherein a signal obtained by performing phase inversion of the sound signal from the other party, to be superimposed on the sound signal collected by the second microphone, is outputted to the other party.

18. A headset comprising, built into a same casing:
a microphone;
a speaker; and
a noise canceling circuit in which a sound signal collected by the microphone undergoes phase inversion, to be superimposed on a sound signal from an other party, and is outputted to the speaker; wherein
a sound signal collected by the microphone is outputted to the other party.

19. The headset according to claim 18, further comprising a filter which removes a high frequency component of the sound signal collected by the microphone, wherein output of the filter is transmitted to the other party.
